(19) United States
(12) Patent Application Publication
(10) Pub. No.: US 2023/0353906 A1
(43) Pub. Date: Nov. 2, 2023

(54) SOLID-STATE IMAGING DEVICE AND SOLID-STATE IMAGING SYSTEM

(71) Applicant: Panasonic Intellectual Property Management Co., Ltd., Osaka (JP)

(72) Inventors: Toru OKINO, OSAKA FU (JP); Shinzo KOYAMA, OSAKA FU (JP); Shigeru SAITOU, KYOTO FU (JP); Masato TAKEMOTO, OSAKA FU (JP); Masaki TAMARU, KYOTO FU (JP); Hiroshi KOSHIDA, OSAKA FU (JP); Shigetaka KASUGA, OSAKA FU (JP); Yugo NOSE, KYOTO FU (JP)

(21) Appl. No.: 18/345,805

(22) Filed: Jun. 30, 2023

Related U.S. Application Data
(63) Continuation of application No. PCT/JP2022/013423, filed on Mar. 23, 2022.

(30) Foreign Application Priority Data
Mar. 30, 2021 (JP) 2021-057120

(51) Int. Cl. H04N 25/779; H04N 25/69

(52) U.S. Cl. CPC H04N 25/779; H04N 25/69

(57) ABSTRACT

Effective pixels and a failure detection pixel are connected to a control signal line for controlling an operation of the pixels and to an output signal line for outputting a result of failure detection in the pixels. Among the effective pixels, the effective pixels in a same row are connected in common to a same control signal line, and the effective pixels in a same column are connected in common to a same output signal line. The failure detection pixel is connected in common to at least one of the control signal line or the output signal line and configured to detect a failure in any of the effective pixels connected to the at least one of the control signal line or the output signal line.

### CROSS-REFERENCE TO RELATED APPLICATIONS

This is a continuation of International Application No. PCT/JP2022/013423 filed on Mar. 23, 2022, which claims priority to Japanese Patent Application No. 2021-057120 filed on Mar. 30, 2021. The entire disclosures of these applications are incorporated by reference herein.

### BACKGROUND

The present disclosure relates to a solid-state imaging device and a solid-state imaging system.

Solid-state imaging devices that capture images using an image sensor are typically known. In recent years, the field of applying products using a solid-state imaging device has been expanding, and solid-state imaging devices are mounted on an automobile and used for monitoring the inside and outside of the automobile. There is a high possibility that such a solid-state imaging device for on-vehicle applications will endanger a life in case of a failure, as compared to consumer applications, such as typical digital cameras and video cameras. The system itself thus needs to have a high reliability and a mechanism that is fail-safe even in case of a failure.

Japanese Unexamined Patent Publication No. 2009-118427 describes a solid-state imaging device having pixels including photodiodes (PDs) and pixels not including a photodiode in a pattern area for failure detection. The device in Japanese Unexamined Patent Publication No. 2009-118427 can obtain an output signal based on the array pattern of the pixels including PDs and the pixels not including PDs even under a dark environment and can thus detect a failure of an image sensor in outputting a signal (i.e., outputting no signal).

A device in Japanese Patent Application No. 2003-101885 includes a defective pixel address storage means for storing the address of a defective sensor cell detected through a wafer-level test, and a defective pixel correction means for replacing data on the defective pixel with data on normal pixels around the defective pixel and outputting the normal pixel data to an image signal processing means. In Japanese Patent Application No. 2003-101885, the device stores an address corresponding to the defective cell of the image sensor where a defective pixel cell has occurred and compensate and correct the data value so that even an image sensor chip including the defective sensor cell can be used in the same manner as the normal image sensor.

### SUMMARY

Japanese Unexamined Patent Publication No. 2009-118427 discloses that a failure during an operation of the solid-state imaging device is detectable but does not specify the pixel with the failure. If there is a failure in the solid-state imaging device, continuous use of the solid-state imaging device may be impossible. Thus, when used, for example, in an automobile, the solid-state imaging device according to Japanese Unexamined Patent Publication No. 2009-118427 needs to have a redundant configuration, such as a configuration including a plurality of solid-state imaging devices in case of a failure. This increases the scale and costs of the solid-state imaging device.

Japanese Patent Application No. 2003-101885 is a configuration specifying a defective pixel cell in a manufacturing process of the image sensor, and therefore cannot deal with a failure during the use of the solid-state imaging device.

It is an objective of the present disclosure to provide a solid-state imaging device and a solid-state imaging system capable of operating continuously even in the event of a failure, at a smaller scale and lower costs.

In order to achieve the objective, a solid-state imaging device according to an embodiment of the present disclosure includes: a plurality of effective pixels arranged in a matrix and each including a photodiode; and a failure detection pixel configured to detect a failure in any of the effective pixels, the effective pixels and the failure detection pixel being connected to a control signal line for controlling an operation of the pixels and to an output signal line for outputting a result of failure detection in the pixels, among the plurality of effective pixels, the effective pixels in a same row being connected in common to a same control signal line, and the effective pixels in a same column being connected in common to a same output signal line, the failure detection pixel being connected in common to at least one of the control signal line or the output signal line and configured to detect a failure in any of the effective pixels connected to the at least one of the control signal line or the output signal line.

The present disclosure allows continuous operation of a solid-state imaging device even in the event of a failure, at a smaller scale and lower costs.

### BRIEF DESCRIPTION OF THE DRAWINGS

FIG. 1 is a block diagram showing an example overall configuration of a solid-state imaging device.

FIG. 2 is a diagram showing an example circuit formed in an effective pixel according to a first embodiment.

FIG. 3 is a timing diagram showing an operation of the effective pixel according to the first embodiment.

FIGS. 4A to 4B are example circuits formed in a failure detection pixel according to the first embodiment.

FIG. 5 is a diagram for explaining detection of a failure of an effective pixel by the failure detection pixel according to the first embodiment.

FIG. 6 is a diagram for explaining detection of a failure of an effective pixel by the failure detection pixel according to the first embodiment.

FIG. 7 is a plan view showing a layout structure of a pixel array portion according to the first embodiment.

FIGS. 8A to 8D are example circuits formed in each pixel according to a second embodiment.

FIG. 9 is a diagram showing an example circuit configuration of a pixel array portion according to the second embodiment.

FIG. 10 is a diagram for explaining detection of a failure of an effective pixel by the circuit configuration in FIG. 9.

FIG. 11 is a diagram showing another example circuit configuration of the pixel array portion according to the second embodiment.

FIG. 12 is a diagram for explaining detection of a failure of an effective pixel by the circuit configuration in FIG. 11.

FIG. 13 is a diagram showing another example circuit configuration of the pixel array portion according to the second embodiment.

FIG. 14 is a diagram showing another example circuit configuration of the pixel array portion according to the second embodiment.

FIG. 15 is a block diagram of a solid-state imaging system including a solid-state imaging device.

FIG. 16 is a diagram showing an example image generated from an output of the solid-state imaging device.

### DETAILED DESCRIPTION

Hereinafter, embodiments of the present disclosure will be described in detail with reference to the drawings. The following description of advantageous embodiments is only an example in nature, and is not intended to limit the scope, applications or use of the present disclosure.

(Overall Configuration of Solid-State Imaging Device)

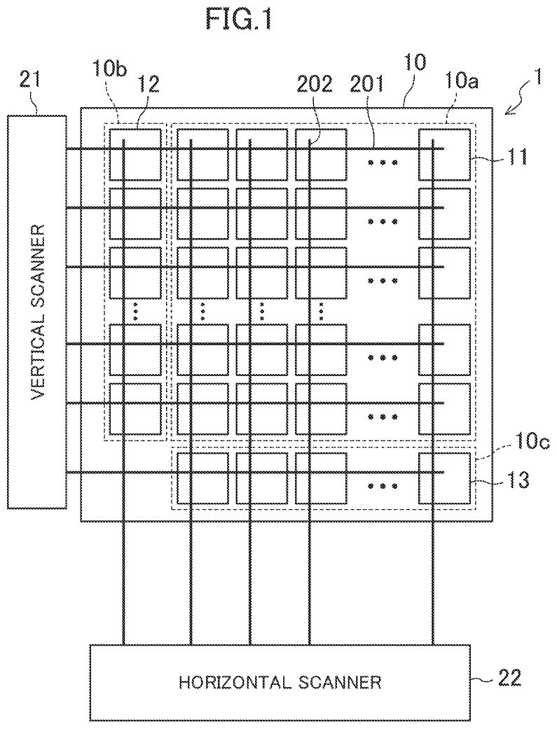

FIG. 1 is a block diagram showing an example overall configuration of a solid-state imaging device. As shown in FIG. 1, a solid-state imaging device 1 includes a pixel array portion 10, a vertical scanner 21, and a horizontal scanner 22. In and around the pixel array portion 10, control signal lines 201 are arranged for respective pixel rows, and output signal lines 202 are arranged for respective pixel columns.

The pixel array portion 10 includes a plurality of pixels 100 to 103 in a matrix. The pixel array portion 10 includes an effective pixel area 10a, a row failure detection pixel area 10b, and a column failure detection pixel area 10c. Effective pixels 11 each including a photodiode and subjected to optical detection are arranged in the effective pixel area 10a. Row failure detection pixels 12, each configured to detect a failure of the effective pixels 11 arranged in the same row, are arranged in the row failure detection pixel area 10b. Column failure detection pixels 13, each configured to detect a failure of the effective pixels 11 arranged in the same column, are arranged in the column failure detection pixel area 10c. That is, the row failure detection pixel 12 is arranged for each row of the effective pixel area 10a, and the column failure detection pixels 13 is arranged for each column of the effective pixel area 10a. The row failure detection pixels 12 and the column failure detection pixels 13 correspond to the “failure detection pixels.”

As shown in FIG. 1, the effective pixels 11 and the row failure detection pixel 12 arranged in the same row are connected in common to the same control signal line 201. The effective pixels 11 and the column failure detection pixel 13 arranged in the same column are connected in common to the same output signal line 202. The row failure detection pixels 12 aligned in the same row are connected to the same output signal line 202, while the column failure detection pixels 13 aligned in the same column are connected to the same control signal line 201.

The row failure detection pixels 12 are for detecting a failure of the effective pixels 11 connected in common to the same control signal line 201. Although details will be described later, each effective pixel 11 drives a transistor in the pixel in accordance with a control signal input via the control signal line 201. At this time, unless the control signal is input to the effective pixel 11 correctly, the effective pixel 11 does not operate normally. The row failure detection pixel 12 receives the control signals input to the effective pixels 11 arranged in the same row via the control signal line 201, and outputs a signal for determining whether the control signal is normal. That is, the provision of the row failure detection pixels 12 in the solid-state imaging device 1 allows detection of a failure of the effective pixels 11 arranged in the same row as the respective row failure detection pixel 12. It is thus possible to specify which row of the pixel array portion 10 includes the effective pixel 11 with the failure. With measures, such as not using the result output by the pixel row including the effective pixel 11 with the failure, it is possible to operate the solid-state imaging device 1 continuously even in the event of a failure, without a redundant configuration of the solid-state imaging device 1. This allows continuous operation of the solid-state imaging device even in the event of a failure, at a smaller scale and lower costs.

The column failure detection pixels 13 are for detecting a failure of the effective pixels 11 connected in common to the same output signal line 202. Although details will be described later, each effective pixel 11 outputs, to the output signal line 202, a pixel signal and a reference signal, as a result of failure detection in the effective pixel 11, in accordance with a control signal input via the control signal line 201. At this time, the effective pixel 11 may not always output a normal output result (i.e., the pixel signal and the reference signal). The column failure detection pixel 13 outputs a signal for determining whether the results output by the effective pixels 11 arranged in the same column are normal. That is, the provision of the column failure detection pixels 13 in the solid-state imaging device 1 allows detection of a failure of the effective pixels 11 arranged in the same column as the respective column failure detection pixel 13. It is thus possible to specify which column of the pixel array portion 10 includes the effective pixel 11 with the failure. With measures, such as not using the result output by the pixel column including the effective pixel 11 with the failure, it is possible to operate the solid-state imaging device 1 continuously even in the event of a failure, without a redundant configuration of the solid-state imaging device 1. This allows continuous operation of the solid-state imaging device even in the event of a failure, at a smaller scale and lower costs.

In FIG. 1, the effective pixels 11 and the row failure detection pixel 12 arranged in the same row are connected in common to one control signal line 201, but may be connected in common to a plurality of control signal lines 201. Each row of the effective pixel area 10a has one row failure detection pixel 12 in FIG. 1, but each row of the effective pixel area 10a may have a plurality of row failure detection pixels 12. In this case, the plurality of row failure detection pixels 12 may have configurations different from each other. Similarly, each column of the effective pixel area 10a has one column failure detection pixel 13 in FIG. 1, but each column of the effective pixel area 10a may have a plurality of column failure detection pixels 13. In this case, the plurality of column failure detection pixels 13 may have configurations different from each other.

The row failure detection pixel area 10b is arranged on the left of the effective pixel area 10a in FIG. 1, but the row failure detection pixel area 10b may be arranged on the right in the figure. Similarly, the column failure detection pixel area 10c is arranged on the lower side of the effective pixel area 10a in FIG. 1, but the column failure detection pixel area 10c may be arranged on the upper side in the figure. The row failure detection pixel area 10b and the column failure detection pixel area 10c do not have to be included in the pixel array portion 10.

The vertical scanner 21 outputs control signals for controlling a reset operation, a charge storage operation, and a readout operation of the effective pixels 11 on a row-by-row basis. The vertical scanner 22 outputs the control signals to the effective pixels 11, the row failure detection pixels 12, and the column failure detection pixels 13 via the control signal lines 201.

The horizontal scanner 22 has the function of reading (outputting) the pixel signals and the reference signals output from the effective pixels 11 to an output circuit (not shown) via the output signal lines 202.

### First Embodiment

—Configuration of Effective Pixel—

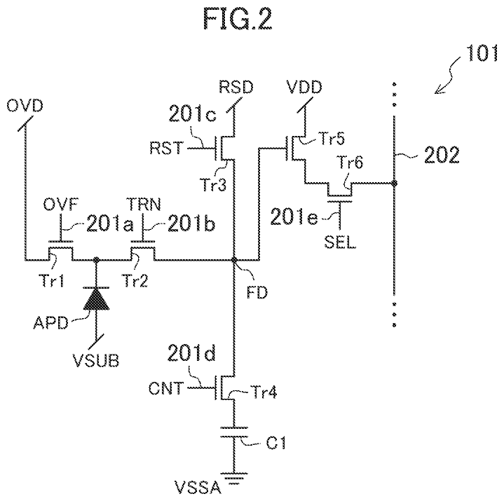

FIG. 2 is a diagram showing an example circuit formed in an effective pixel according to a first embodiment. An effective pixel 101 in FIG. 2 is placed as one of the effective pixels 11 in FIG. 1 in the effective pixel area 10a. In FIG. 2, five control signal lines 201 (namely, control signal lines 201a to 201e) are provided for one effective pixel 101. The vertical scanner 22 outputs control signals (namely, a first reset signal OVF, an exposure signal TRN, a second reset signal RST, a count signal CNT, and a selection signal SEL, which will be described later) to the effective pixel 101 via the control signal lines 201a to 201e and controls the operation of the effective pixel 101.

Specifically, each effective pixel 101 includes an avalanche photodiode APD, an overflow transistor Tr1, a transfer gate transistor Tr2, a reset transistor Tr3, a count transistor Tr4, a memory capacitor C1, an amplifier transistor Try, and a selection transistor Tr6.

The avalanche photodiode APD performs photoelectric conversion of converting incident light into a signal charge. The avalanche photodiode APD amplifies the generated signal charge several times to several hundred thousand times. The avalanche photodiode APD is interposed between the overflow transistor Tr1 and the transfer gate transistor Tr2 and has one end connected to a voltage VSUB.

The overflow transistor Tr1 receives, at its gate, the first reset signal OVF via the control signal line 201a, and resets the voltage inside the avalanche photodiode APD to a first reset voltage OVD when the first reset signal OVF is at high level.

The transfer gate transistor Tr2 receives, at its gate, the exposure signal TRN via the control signal line 201b, and transfers the signal charge inside the avalanche photodiode APD to a floating diffusion FD when the exposure signal TRN is at high level. That is, when the exposure signal TRN is at high level, the effective pixel 101 performs the exposure.

The reset transistor Tr3 receives, at its gate, the second reset signal RST via the control signal line 201c, and resets the floating diffusion FD to a second reset voltage RSD when the second reset signal RST is at high level.

The count transistor Tr4 receives, at its gate, the count signal CNT via the control signal line 201d, and transfers the signal charge stored in the floating diffusion FD to the memory capacitor C1 when the count signal CNT is at high level. The memory capacitor C1 has one end connected to a ground voltage VSSA and stores the signal charge transferred from the count transistor Tr4. That is, the memory capacitor C1 stores the signal charge according to the result of exposure.

The amplifier transistor Tr5 amplifies the voltage corresponding to the signal charge stored in the floating diffusion FD and outputs the amplified voltage to the selection transistor Tr6.

The selection transistor Tr6 receives, at its gate, a selection signal SEL via the control signal line 201e, and outputs a pixel signal corresponding to the voltage received from the amplifier transistor Tr5 to the output signal line 202 when the selection signal SEL is at high level. That is, when the selection signal SEL is at high level, the pixel signal is read from the effective pixel 101.

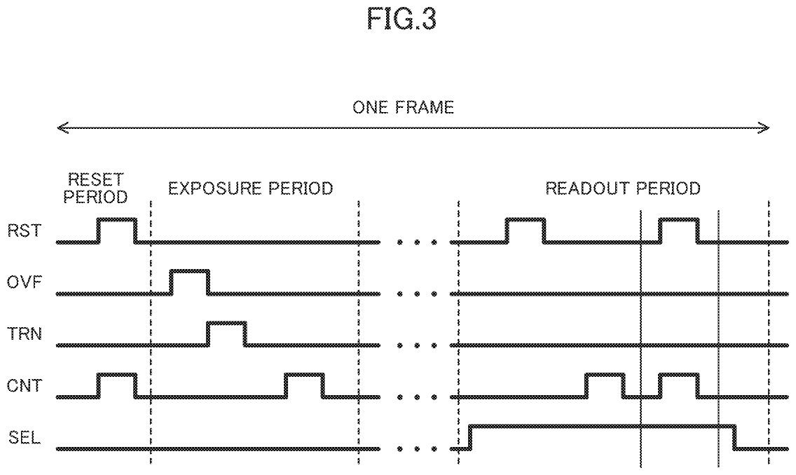

FIG. 3 is a timing diagram showing an operation of each effective pixel according to the first embodiment. FIG. 3 shows an operation of one effective pixel 101.

As shown in FIG. 3, one frame includes a reset period, an exposure period, and an exposure period. The effective pixel 101 repeatedly executes the operation in the one frame. One frame includes exposure periods plural times (e.g., fifteen times).

In the reset period, the second reset signal RST and the count signal CNT become high level, and the first reset signal OVF, the exposure signal TRN, and the selection signal SEL are at low level. Thus, the reset transistor Tr3 and the count transistor Tr4 are turned on, and the overflow transistor Tr1, the transfer gate transistor Tr2, and the selection transistor Tr6 are turned off. Accordingly, the floating diffusion FD and the memory capacitor C1 are reset to the second reset voltage RSD. After that, the second reset signal RST and the count signal CNT become low level, and the reset transistor Tr3 and the count transistor Tr4 are turned off.

In the exposure period, first, the first reset signal OVF becomes high level, and the overflow transistor Tr1 is thus turned on. Accordingly, the avalanche photodiode APD is reset to the first reset voltage OVD.

Next, the first reset signal OVF becomes low level and the exposure signal TRN becomes high level. Thus, the overflow transistor Tr1 is turned off and the transfer gate transistor Tr2 is turned on. Accordingly, the effective pixel 101 is exposed to light, and the signal charge generated by the avalanche photodiode APD is transferred to the floating diffusion FD.

Next, the exposure signal TRN becomes low level and the count signal CNT becomes high level. Thus, the transfer gate transistor Tr2 is turned off and the count transistor Tr4 is turned on. Accordingly, the signal charge transferred to the floating diffusion FD is stored in the memory capacitor C1. After that, the count signal CNT becomes low level, and the count transistor Tr4 is turned off. As described above, since one frame includes a plurality of exposure periods, the effective pixel 101 performs the operation in the exposure period a plurality of times.

In the readout period, first, the selection signal SEL becomes high level, and the selection transistor Tr6 is thus turned on. Next, the second reset signal RST becomes high level, and the reset transistor Tr3 is thus turned on. Accordingly, the floating diffusion FD is reset to the second reset voltage RSD. Next, the second reset signal RST becomes low level and the count signal CNT becomes high level. Thus, the reset transistor Tr3 is turned off and the count transistor Tr4 is turned on. Accordingly, a pixel signal is output to the output signal line 202 in accordance with the charge stored in the memory capacitor C1. After that, the count signal CNT becomes low level, and the count transistor Tr4 is thus turned off.

Next, the second reset signal RST and the count signal CNT become high level, and the reset transistor Tr3 and the count transistor Tr4 are thus turned on. Accordingly, the floating diffusion FD is reset to the second reset voltage RSD and the reference signal is output to the output signal line 202. That is, the effective pixel 101 outputs the pixel signal and the reference signal to the output signal line 202. By comparing the potentials of (i.e., obtaining the potential difference) between the pixel signal and the reference signal, the amount of light detected by the effective pixel 101 in one frame can be detected accurately. After that, the second reset signal RST and the count signal CNT become low level, and the reset transistor Tr3 and the count transistor Tr4 are thus turned off.

—Configuration of Failure Detection Pixel—

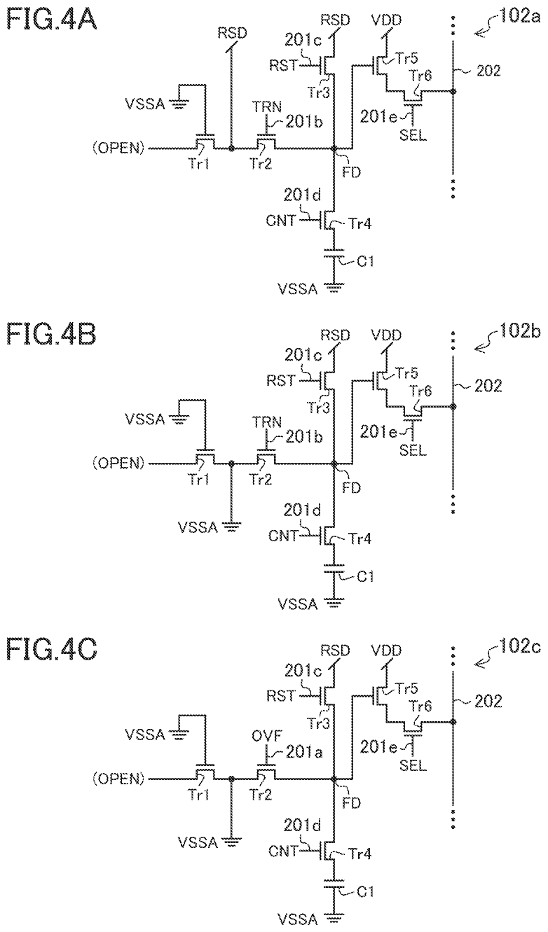

FIGS. 4A to 4B are example circuits formed in a failure detection pixel according to the first embodiment. FIGS. 4A to 4C show circuits formed in failure detection pixels 102a to 102c, respectively. The failure detection pixels 102a to 102c are arranged in the pixel array portion 10 as the row failure detection pixel 12 or the column failure detection pixel 13 in FIG. 1. In FIGS. 4A to 4C, each of the control signal lines 201a to 201e is connected in common to the pixels (the effective pixels 101 and the one of the failure detection pixels 102a to 102c) arranged in the same row.

As shown in FIG. 4A, different from the effective pixel 101 in FIG. 2, the failure detection pixel 102a includes the overflow transistor Tr1 with a gate supplied with the ground voltage VSSA and one end open. In addition, in place of the avalanche photodiode APD, the second reset voltage RSD is connected between the overflow transistor Tr1 and the transfer gate transistor Tr2. That is, the overflow transistor Tr1 is always off, and the transfer gate transistor Tr2 resets the floating diffusion FD to the second reset voltage RSD in response to the exposure signal TRN. The failure detection pixel 102a thus outputs the pixel signal and the reference signal which indicate the same level of voltage (i.e., the second reset voltage RSD).

As shown in FIG. 4B, different from the effective pixel 101 in FIG. 2, the failure detection pixel 102b includes the overflow transistor Tr1 with a gate supplied with the ground voltage VSSA and one end open. In addition, in place of the avalanche photodiode APD, the ground voltage VSSA is connected between the overflow transistor Tr1 and the transfer gate transistor Tr2. That is, the overflow transistor Tr1 is always in off, and the transfer gate transistor Tr2 resets the floating diffusion FD to the ground voltage VSSA in response to the exposure signal TRN. The failure detection pixel 102b thus outputs the pixel signal and the reference signal which indicate the different levels of voltage (i.e., the ground voltage VSSA and the second reset voltage RSD).

As shown in FIG. 4C, different from the effective pixel 101 in FIG. 2, the failure detection pixel 102c includes the overflow transistor Tr1 with a gate supplied with the ground voltage VSSA and one end open. In addition, in place of the avalanche photodiode APD, the ground voltage VSSA is connected between the overflow transistor Tr1 and the transfer gate transistor Tr2. The transfer gate transistor Tr2 receives, at its gate, the first reset signal OVF via the control signal line 201a. That is, the overflow transistor Tr1 is always off, and the transfer gate transistor Tr2 resets the floating diffusion FD to the ground voltage VSSA in response to the first reset signal OVF. The failure detection pixel 102c outputs the pixel signal and the reference signal which indicate the different levels of voltage (i.e., the ground voltage VSSA and the second reset voltage RSD).

Although detailed description is omitted, the failure detection pixels 102a to 102c perform the same operation (the operation shown in FIG. 3) as the effective pixels 101.

—Failure Detection for Effective Pixel by Failure Detection Pixel—

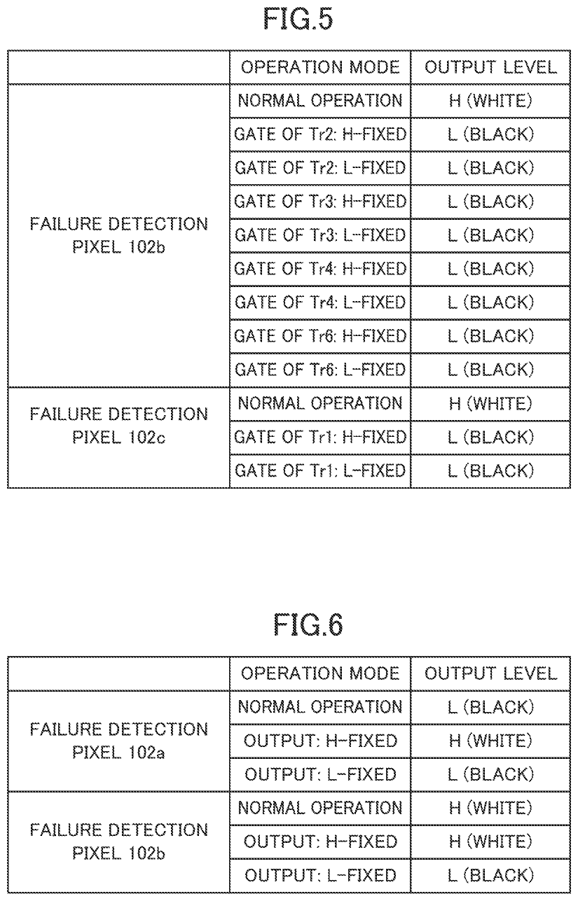

FIGS. 5 and 6 are diagrams for explaining detection of a failure of each effective pixel by the failure detection pixel according to the first embodiment. FIG. 5 shows a relationship between the operation states (operation modes) of the effective pixel 101 and the output level of a row failure detection pixel in a case in which the failure detection pixel 102b or the failure detection pixel 102c is placed as the row failure detection pixel 12. FIG. 6 shows a relationship between the operation states (operation modes) of the effective pixel 101 and the output level of a row failure detection pixel in a case in which the failure detection pixel 102a and the failure detection pixel 102b are placed as the column failure detection pixel 13.

In the description below, under circumstances where control signals cannot be output normally to the respective effective pixels 101 in the same row via the control signal lines 201a to 201e due to, for example, a failure of the vertical scanner 22, the state in which a signal input to the gate of the transistor included in an effective pixel 101 is fixed to a high level (i.e., the corresponding transistor is always on) may be referred to as “H-fixed,” and the stated in which the signal is fixed to a low level (i.e., the corresponding transistor is always off) may be referred to as “L-fixed.” In these cases, the effective pixels 101 in the same row cannot operate normally and can thus be considered having a failure.

The state in which an effective pixel 101 has a failure and always outputs a high-level signal may be referred to as “H-fixed,” whereas the state in which an effective pixel 101 has a failure and always outputs a low-level signal may be referred to as “L-fixed.” In these cases, the effective pixels 101 in the same column cannot output the pixel signals or the reference signals normally and can thus be considered having a failure.

As shown in FIG. 5, in the case in which the failure detection pixel 102b is placed in the pixel array portion 10 as a row failure detection pixel 12, a potential difference is caused between the pixel signal and the reference signal output by the failure detection pixel 102b when the effective pixels 101 have no failure (in a normal operation). Accordingly, the output of the failure detection pixel 102b is the high level (i.e., white).

On the other hand, the transfer gate transistor Tr2 of the failure detection pixel 102b is always on when the transfer gate transistor Tr2 of the effective pixel 101 is H-fixed; therefore, the potential of the floating diffusion FD of the failure detection pixel 102b is the ground voltage VSSA even after the floating diffusion FD of the failure detection pixel 102b is reset to the second reset voltage RSD. Accordingly, no potential difference is caused between the pixel signal and the reference signal output by the failure detection pixel 102b, and the output of the failure detection pixel 102b is the low level (i.e., black).

The transfer gate transistor Tr2 of the failure detection pixel 102b is always off when the transfer gate transistor Tr2 of the effective pixel 101 is L-fixed; therefore, the floating diffusion FD of the failure detection pixel 102b is always reset to the second reset voltage RSD. Accordingly, no potential difference is caused between the pixel signal and the reference signal output by the failure detection pixel 102b, and the output of the failure detection pixel 102b is the low level (i.e., black).

The reset transistor Tr3 of the failure detection pixel 102b is always on when the reset transistor Tr3 of the effective pixel 101 is H-fixed; therefore, the floating diffusion FD of the failure detection pixel 102b is always reset to the second reset voltage RSD. Accordingly, no potential difference is caused between the pixel signal and the reference signal output by the failure detection pixel 102b, and the output of the failure detection pixel 102b is the low level (i.e., black).

The reset transistor Tr3 of the failure detection pixel 102b is always off when the reset transistor Tr3 of the effective pixel 101 is L-fixed; therefore, the potential of the floating diffusion FD of the failure detection pixel 102b is always the ground voltage VSSA. Accordingly, no potential difference is caused between the pixel signal and the reference signal output by the failure detection pixel 102b, and the output of the failure detection pixel 102b is the low level (i.e., black).

The count transistor Tr4 of the failure detection pixel 102b is always on when the count transistor Tr4 of the effective pixel 101 is H-fixed; therefore, the memory capacitor C1 of the failure detection pixel 102b is always reset to the second reset voltage RSD. Accordingly, no potential difference is caused between the pixel signal and the reference signal output by the failure detection pixel 102b, and the output of the failure detection pixel 102b is the low level (i.e., black).

The count transistor Tr4 of the failure detection pixel 102b is always off when the count transistor Tr4 of the effective pixel 101 is L-fixed; therefore, the floating diffusion FD of the failure detection pixel 102b is always reset to the second reset voltage RSD. Accordingly, no potential difference is caused between the pixel signal and the reference signal output by the failure detection pixel 102b, and the output of the failure detection pixel 102b is the low level (i.e., black).

The selection transistor Tr6 of the failure detection pixel 102b is always off when the selection transistor Tr6 of the effective pixel 101 is L-fixed. Accordingly, the failure detection pixel 102b does not output the pixel signal and the reference signal at all times, and the output of the failure detection pixel 102b is the low level (i.e., black).

As described above, the failure detection pixel 102b outputs the low level (black) signal in the event of a failure (i.e., anomalies in the exposure signal TRN, the second reset signal RST, the count signal CNT, and the selection signal SEL) of an effective pixel 101 in the same row, thereby making it possible to specify the pixel row including the effective pixel 101 with the failure.

Here, the selection transistor Tr6 of the failure detection pixel 102b is always on when the selection transistor Tr6 of the effective pixel 101 is H-fixed. Accordingly, the pixel signal and the reference signal output by the failure detection pixel arranged in another row (e.g., an adjacent row) and connected to the same output signal line 202 as the failure detection pixel 102b are mixed into the result output by the failure detection pixel 102b. Thus, the provision, in another row, of a failure detection pixel (e.g., the failure detection pixel 102a) which outputs a low-level (i.e., black) signal causes the output of the failure detection pixel 102b to be the low level (i.e., black) when any effective pixel 101 has a failure. It is thus possible to specify the pixel row including the effective pixel 101 with the failure. In the case of arranging a failure detection pixel that outputs a low-level (i.e., black) signal in a row (another row) different from the failure detection pixel 102b, the arrangement of this failure detection pixel and the failure detection pixel 102b in adjacent pixel rows can improve the accuracy in detecting a failure in the effective pixels 11.

As shown in FIG. 5, in the case in which the failure detection pixel 102c is placed in the pixel array portion 10 as a row failure detection pixel 12, a potential difference is caused between the pixel signal and the reference signal output by the failure detection pixel 102c when the effective pixels 101 have no failure (in a normal operation). Accordingly, the output of the failure detection pixel 102c is the high level (i.e., white).

On the other hand, the transfer gate transistor Tr2 of the failure detection pixel 102c is always on when the overflow transistor Tr1 of the effective pixel 101 is H-fixed; therefore, the potential of the floating diffusion FD of the failure detection pixel 102c is the ground voltage VSSA even after the floating diffusion FD of the failure detection pixel 102c is reset to the second reset voltage RSD. Accordingly, no potential difference is caused between the pixel signal and the reference signal output by the failure detection pixel 102c, and the output of the failure detection pixel 102c is the low level (i.e., black).

The transfer gate transistor Tr2 of the failure detection pixel 102c is always off when the overflow transistor Tr1 of the effective pixel 101 is L-fixed; therefore, the floating diffusion FD of the failure detection pixel 102c is always reset to the second reset voltage RSD. Accordingly, no potential difference is caused between the pixel signal and the reference signal output by the failure detection pixel 102c, and the output of the failure detection pixel 102b is the low level (i.e., black).

As described above, the failure detection pixel 102c outputs the low level (black) signal upon detection of a failure (i.e., anomaly in the first reset signal OVF) of any effective pixel 101 in the same row, thereby making it possible to specify the pixel row including the effective pixel 101 with the failure.

FIG. 6 shows the results output by the failure detection pixels 102a and 102b in a case in which the failure detection pixels 102a and 102b are arranged in the same column as the column failure detection pixels 13.

As shown in FIG. 6, in the case in which the failure detection pixel 102a is placed in the pixel array portion 10 as a column failure detection pixel 13, the floating diffusion FD of the failure detection pixel 102a is always reset to the second reset voltage RSD as described above when the effective pixels 101 have no failure (in a normal operation). Accordingly, no potential difference is caused between the pixel signal and the reference signal output by the failure detection pixel 102a, and the output of the failure detection pixel 102a is the low level (i.e., black).

On the other hand, if the outputs of the effective pixels 101 in the same column are H-fixed, a high-level signal is always output to the output signal line 202; therefore, the output of the failure detection pixel 102a is the high level (i.e., white).

In the case in which the failure detection pixel 102c is placed in the pixel array portion as a column failure detection pixel 13, a potential difference is caused between the pixel signal and the reference signal output by the failure detection pixel 102c, as described above, when the effective pixels 101 have no failure (in a normal operation). Thus, the output of the failure detection pixel 102c is the high level (i.e., white).

On the other hand, if the outputs of the effective pixels 101 in the same column are H-fixed, a low-level signal is always output to the output signal line 202; therefore, the output of the failure detection pixel 102b is the low level (i.e., black).

As described above, the failure detection pixel 102a outputs the high-level (i.e., white) signal in the event of a failure in any of the effective pixels 101 in the same column (i.e., the output is H-fixed). On the other hand, the failure detection pixel 102b outputs the low-level (i.e., black) signal in the event of a failure in any of the effective pixels 101 in the same column (i.e., the output is L-fixed). The arrangement of the failure detection pixels 102a and 102b in the same column as the effective pixel 101 makes it possible to specify the pixel column including the effective pixel 101 with the failure.

—Layout Structure of Pixel Array Portion—

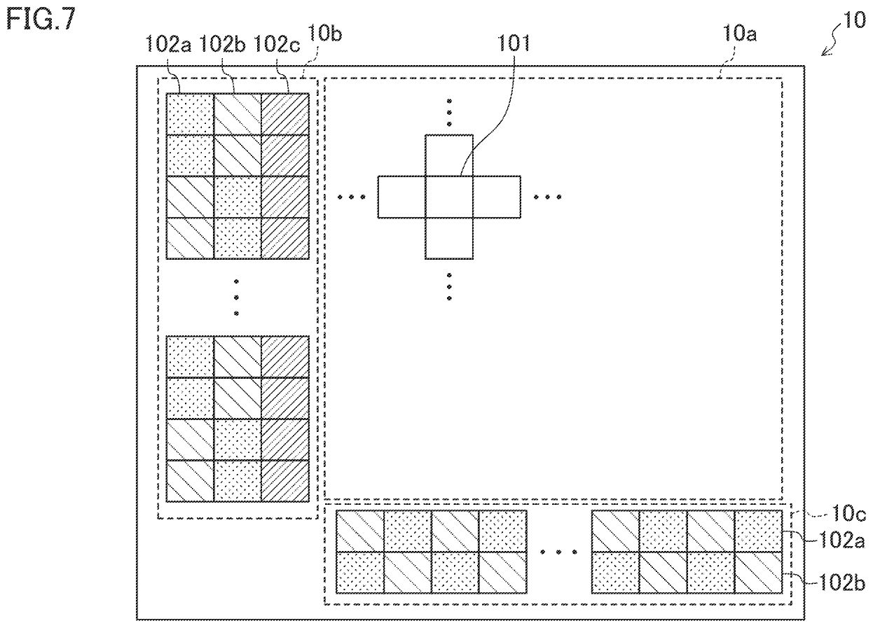

FIG. 7 is a plan view showing a layout structure of a pixel array portion according to the first embodiment.

As shown in FIG. 7, the effective pixels 101 are arranged in a matrix in each of a plurality of effective pixel areas 10a.

Failure detection pixels 102a and 102b are arranged in the row failure detection pixel area 10b. Two failure detection pixels 102a and two failure detection pixels 102b are alternately arranged in the left and center columns in the figure in the row failure detection pixel area 10b. The failure detection pixels 102c are arranged in the right column in the figure in the row failure detection pixel area 10b. This arrangement allows detection of the H- and L-fixed states of the transistors Tr1, Tr2, Tr3, and Tr4 and the L-fixed state of the transistor Tr6 of each of the effective pixels 101 arranged in each row. Since the failure detection pixels 102a and 102b are arranged adjacent to each other in the column direction, it is possible to detect the H-fixed state of the selection transistor Tr6.

Failure detection pixels 102a and 102b are arranged in the column failure detection pixel area 10c. One failure detection pixel 102a and one failure detection pixel 102b are alternately arranged in the upper and lower columns in the figure in the row failure detection pixel area 10b. This arrangement allows detection of the H- and L-fixed states of the outputs of the effective pixels 101 arranged in each column.

### Second Embodiment

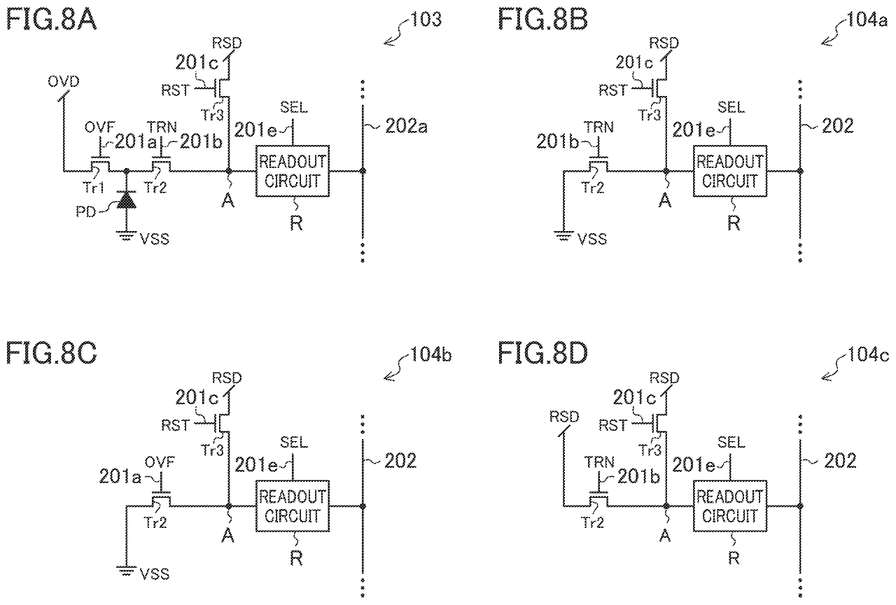

FIGS. 8A to 8D are example circuits formed in respective pixels according to a second embodiment.

—Configuration of Effective Pixel—

The effective pixel 103 in FIG. 8A is arranged as an effective pixel 11 in the effective pixel area 10a of the pixel array portion 10 shown in FIG. 1. As shown in FIG. 8A, the effective pixel 103 includes a photodiode PD, an overflow transistor Tr1, a transfer gate transistor Tr2, a reset transistor Tr3, and a readout circuit R.

The photodiode PD performs photoelectric conversion of converting incident light into a signal charge. The photodiode PD is interposed between the overflow transistor Tr1 and the transfer gate transistor Tr2 and has one end connected to a ground voltage VSS.

The overflow transistor Tr1 receives, at its gate, the first reset signal OVF via the control signal line 201a, and resets the voltage inside the photodiode PD to the first reset voltage OVD when the first reset signal OVF is at high level.

The transfer gate transistor Tr2 receives, at its gate, the exposure signal TRN via the control signal line 201b, and transfers the signal charge inside the photodiode PD to a node A when the exposure signal TRN is at high level. That is, when the exposure signal TRN is at high level, the effective pixel 101 performs the exposure.

The reset transistor Tr3 receives, at its gate, the second reset signal RST via the control signal line 201c, and resets the node A to the second reset voltage RSD when the second reset signal RST is at high level.

The readout circuit R outputs the signal charge stored in the node A to the output signal line 202 in response to the selection signal SEL input via the control signal line 201e.

Although detailed description is omitted, the effective pixel 103 performs the same operation as the effective pixel 101.

—Configuration of Failure Detection Pixel—

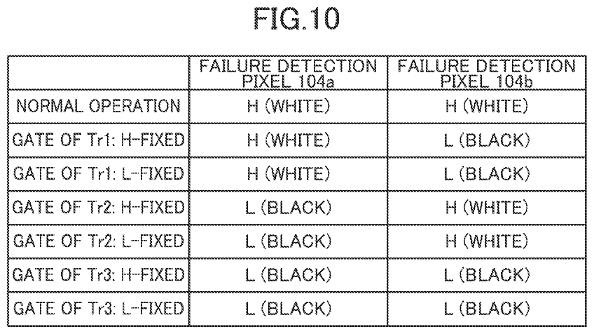

Failure detection pixels 104a to 104c of FIGS. 8B to 8D are arranged in the pixel array portion 10 in FIG. 10 as the row failure detection pixel 12 in the row failure detection pixel area 10b or the column failure detection pixel 13 in the column failure detection pixel area 10c.

As shown in FIG. 8B, the photodiode PD and the overflow transistor Tr1 are omitted in the failure detection pixel 104a, unlike the effective pixel 103 of FIG. 8A. The transfer gate transistor Tr2 has one end connected to a ground voltage VSS. The failure detection pixel 104a outputs the pixel signal and the reference signal which indicate the different levels of voltage (i.e., the ground voltage VSS and the second reset voltage RSD).

As shown in FIG. 8C, the photodiode PD and the overflow transistor Tr1 are omitted in the failure detection pixel 104a, unlike the effective pixel 103 of FIG. 8A. The transfer gate transistor Tr2 has one end connected to a ground voltage VSS. The transfer gate transistor Tr2 receives, at its gate, the first reset signal OVF via the control signal line 201a. The failure detection pixel 104b outputs the pixel signal and the reference signal which indicate the different levels of voltage (i.e., the ground voltage VSS and the second reset voltage RSD).

As shown in FIG. 8D, the photodiode PD and the overflow transistor Tr1 are omitted in the failure detection pixel 104a, unlike the effective pixel 103 of FIG. 8A. The transfer gate transistor Tr2 has one end connected to the second reset voltage RSD. The failure detection pixel 104c thus outputs the pixel signal and the reference signal which indicate the same level of voltage (i.e., the second reset voltage RSD).

Although detailed description is omitted, the failure detection pixels 104a to 104c perform the same operation as the failure detection pixels 104a to 104c.

(Circuit Configuration 1)

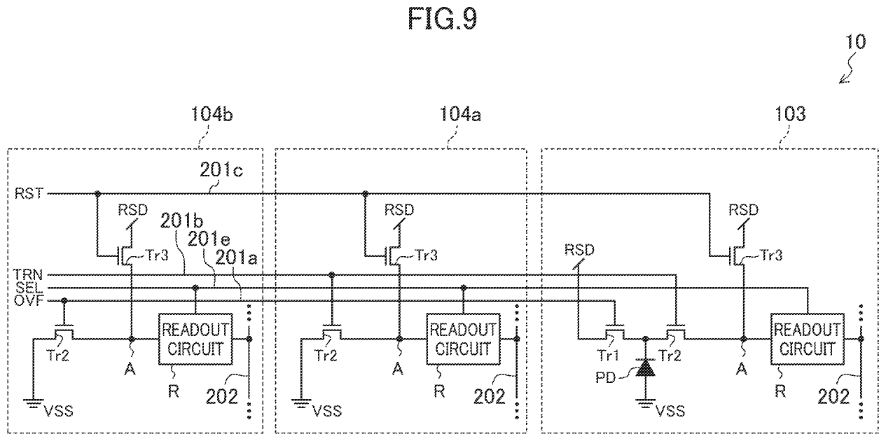

FIG. 9 is a diagram showing an example circuit configuration of a pixel array portion according to the second embodiment. As shown in FIG. 9, the effective pixel 103 and the failure detection pixels 104a and 104b are arranged in the same row in the pixel array portion 10.

FIG. 10 is a diagram for explaining detection of a failure of an effective pixel by the circuit configuration in FIG. 9. As shown in FIG. 10, a potential difference is caused between the pixel signal and the reference signal output by the failure detection pixel 102a when the effective pixels 101 have no failure (in a normal operation). Thus, the output of the failure detection pixel 102a is the high level (i.e., white). Similarly, in a normal operation of the effective pixels 101, a potential difference is caused between the pixel signal and the reference signal output by the failure detection pixel 102b. Thus, the output of the failure detection pixel 102b is the high level (i.e., white).

On the other hand, the transfer gate transistor Tr2 of the failure detection pixel 104b is always on when the overflow transistor Tr1 of the effective pixel 103 is H-fixed; therefore, the potential of the node A of the failure detection pixel 104b is the ground voltage VSS even after the node A of the failure detection pixel 104b is reset to the second reset voltage RSD. Accordingly, no potential difference is caused between the pixel signal and the reference signal output by output by the failure detection pixel 104b, and the output of the failure detection pixel 104b is the low level (i.e., black).

The transfer gate transistor Tr2 of the failure detection pixel 104b is always off when the overflow transistor Tr1 of the effective pixel 103 is L-fixed; therefore, the node A of the failure detection pixel 104b is always reset to the second reset voltage RSD. Accordingly, no potential difference is caused between the pixel signal and the reference signal output by output by the failure detection pixel 104b, and the output of the failure detection pixel 104b is the low level (i.e., black).

The transfer gate transistor Tr2 of the failure detection pixel 104a is always on when the transfer gate transistor Tr2 of the effective pixel 103 is H-fixed; therefore, the potential of the node A of the failure detection pixel 104a is the ground voltage VSS even after the node A of the failure detection pixel 104a is reset to the second reset voltage RSD. Accordingly, no potential difference is caused between the pixel signal and the reference signal output by the failure detection pixel 104a, and the output of the failure detection pixel 104a is the low level (i.e., black).

The transfer gate transistor Tr2 of the failure detection pixel 104a is always off when the transfer gate transistor Tr2 of the effective pixel 103 is L-fixed; therefore, the node A of the failure detection pixel 104a is always reset to the second reset voltage RSD. Accordingly, no potential difference is caused between the pixel signal and the reference signal output by the failure detection pixel 104a, and the output of the failure detection pixel 104a is the low level (i.e., black).

The reset transistors Tr3 of the failure detection pixels 104a and 104b are always on when the reset transistor Tr3 of the effective pixel 103 is H-fixed; therefore, the nodes A of the failure detection pixels 104a and 104b are always reset to the second reset voltage RSD. Accordingly, no potential difference is caused between the pixel signal and the reference signal output by each of the failure detection pixels 104a and 104b, and the outputs of the failure detection pixels 104a and 104b are the low level (i.e., black).

The reset transistors Tr3 of the failure detection pixels 104a and 104b are always off when the reset transistor Tr3 of the effective pixel 103 is L-fixed; therefore, the potential of the node A of each of the failure detection pixels 104a and 104b is always the ground voltage VSS. Accordingly, no potential difference is caused between the pixel signal and the reference signal output by each of the failure detection pixels 104a and 104b, and the outputs of the failure detection pixels 104a and 104b are the low level (i.e., black).

As described above, at least one of the failure detection pixel 104a or 104b outputs the low level (black) signal in the event of a failure (i.e., anomalies in the first reset signal OVF, the exposure signal TRN, and the second reset signal RST) of an effective pixel 101 in the same row, thereby making it possible to specify the pixel row including the effective pixel 101 with the failure.

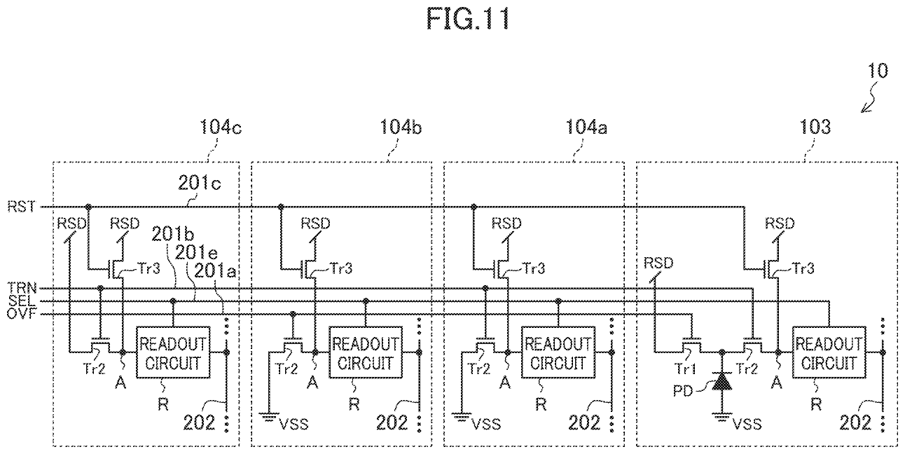

(Circuit Configuration 2) FIG. 11 is a diagram showing another example circuit configuration of the pixel array portion according to the second embodiment. In FIG. 11, the failure detection pixel 104c is arranged in the pixel array portion 10, in addition to the circuit configuration in FIG. 9, in the same row as the effective pixel 103 and the failure detection pixels 104a and 104b. That is, in FIG. 11, the effective pixel 103 and the failure detection pixels 104a to 104c are arranged in the same row.

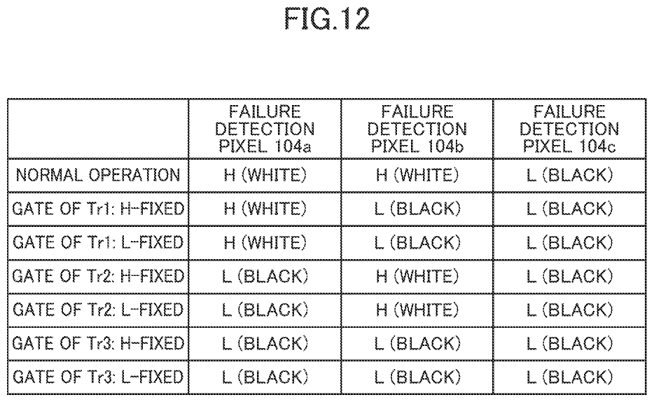

FIG. 12 is a diagram for explaining detection of a failure of an effective pixel by the circuit configuration in FIG. 11. As described above, since the node A is always reset to the second reset voltage RSD, no potential difference is caused between the pixel signal and the reference signal; therefore, the output of the failure detection pixel 104c is the low level (i.e., black).

As shown in FIG. 12, when the effective pixel 103 operates normally (i.e., in a normal operation) or even when any one of the transistors Tr1 to Tr3 of the effective pixel 103 is H- or L-fixed, the output of the failure detection pixel 104c does not change and remains at low level (black). If the output of the failure detection pixel 104c changes, it can be determined that a failure in the effective pixel 101 has occurred by a factor other than the H- and L-fixed states of the transistors Tr1 to Tr3.

(Circuit Configuration 3)

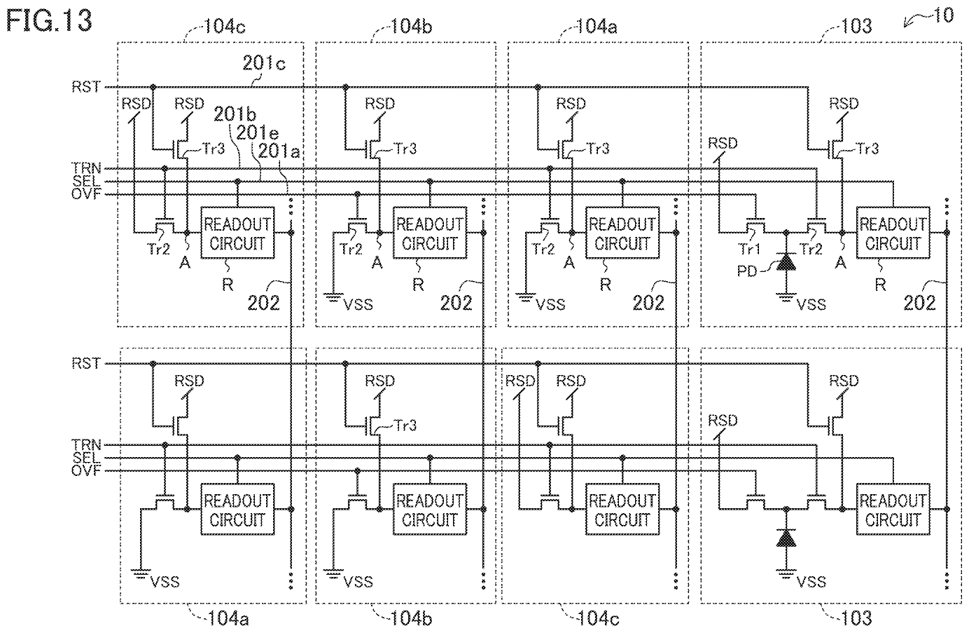

FIG. 13 a diagram showing another example circuit configuration of the pixel array portion according to the second embodiment. In FIG. 13, the pixel array portion 10 includes two pixel rows. Specifically, the failure detection pixels 104c, 104b, and 104a, and the effective pixel 101 are sequentially arranged from the left side of the figure in the upper row, and the failure detection pixels 104a, 104b, and 104c, and the effective pixel 101 are sequentially arranged from the left side of the figure in the lower row. That is, the failure detection pixels 104a and 104c are arranged in the same column and are connected to the same output signal line 202.

As described above, when the effective pixels 101 operate normally (i.e., in a normal operation), the output of the failure detection pixel 104a is the low level (i.e., black), while the output of the failure detection pixel 104c is the high level (i.e., white).

In FIG. 13, when the readout circuit R of the effective pixel 101 in the upper row is H-fixed, the readout circuit R of the failure detection pixel 104c in the upper row is always on, and the output of the failure detection pixel 104c is always the low level (i.e., black). Accordingly, the output of the failure detection pixel 104a in the lower row connected in common to the same output signal line 202 is the low level (i.e., black).

When the readout circuit R of the effective pixel 101 in the lower row is H-fixed, the readout circuit R of the failure detection pixel 104c in the lower row is always on, and the output of the failure detection pixel 104c in the lower row is always the low level (i.e., black). Accordingly, the output of the failure detection pixel 104a in the upper row connected in common to the same output signal line 202 is the low level (i.e., black).

When both the readout circuits R of the effective pixels 101 in the upper and lower rows are H-fixed, the outputs of the failure detection pixels 104a in the upper and lower rows are always the low level. The outputs of the failure detection pixels 104c in the upper and lower rows are always the outputs intermediate between the low level and the high level.

As described above, the outputs of the failure detection pixels 104a and 104c allow detection of a failure (i.e., abnormality in the selection signal SEL) of the effective pixels 101 aligned in the same row. It is therefore possible to specify the pixel row including the effective pixel 101 with the failure.

While the failure detection pixels 104a and 104c in the same column are arranged in adjacent pixel rows in FIG. 13, the pixel rows where the failure detection pixels 104a and 104c are arranged do not have to be adjacent to each other. However, the arrangement of the failure detection pixels 104a and 104c in adjacent pixel rows improves the accuracy in detecting a failure in any of the effective pixels 11.

(Circuit Configuration 4)

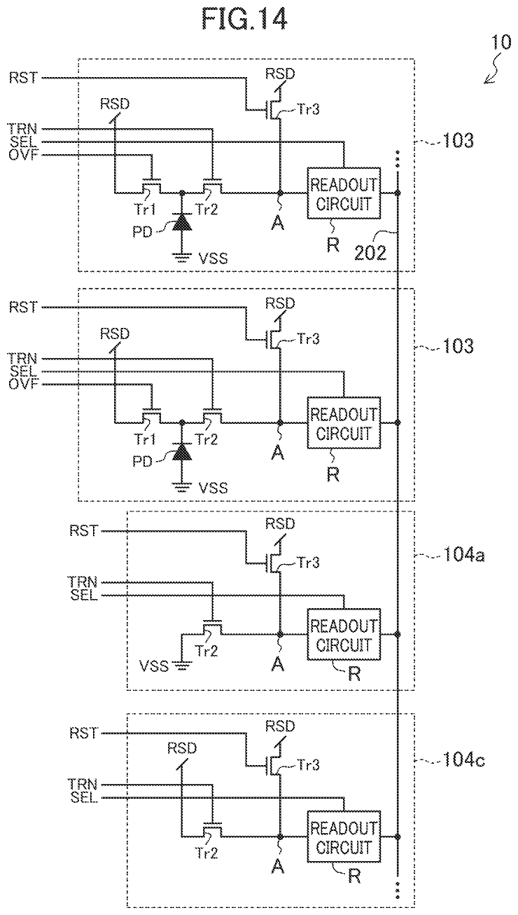

FIG. 14 is a diagram showing another example circuit configuration of the pixel array portion according to the second embodiment. In FIG. 14, two effective pixels 103 and failure detection pixels 104a and 104c are arranged in the same column in the pixel array portion 10. That is, the effective pixels 103 and the failure detection pixels 104a and 104c are connected in common to the same output signal line 202.

As described above, when the effective pixels 103 operate normally (i.e., in a normal operation), the output of the failure detection pixel 104a is the high level (i.e., white), while the output of the failure detection pixel 104c is the low level (i.e., black).

In FIG. 14, when the outputs of the effective pixels 103 are H-fixed, a high-level signal is always output to the output signal line 202; therefore, the output of the failure detection pixel 104c is the high level (i.e., white).

When the outputs of the effective pixels 103 are L-fixed, a low-level signal is always output to the output signal line 202; therefore, the output of the failure detection pixel 104a is the low level (i.e., black).

As described above, when the outputs of the effective pixels 103 are H- or L-fixed, the outputs of the failure detection pixels 104a and 104c arranged in the same column allow detection of a failure in any of the effective pixels 103. It is thus possible to specify the pixel column including the effective pixel 101 with the failure.

(Solid-State Imaging System)

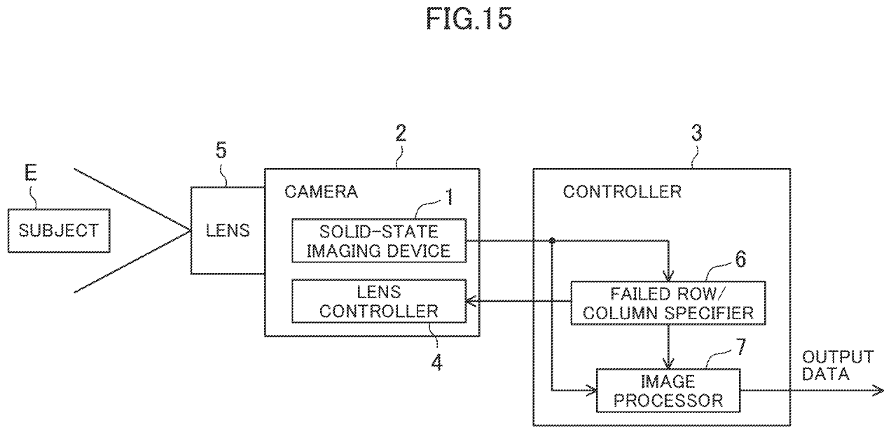

FIG. 15 is a block diagram of a solid-state imaging system including a solid-state imaging device. As shown in FIG. 15, the solid-state imaging system includes a camera 2 (optical system) and a controller 3.

The camera 2 includes the solid-state imaging device 1 according to the first embodiment or the second embodiment, a lens controller 4, and a lens 5. The lens controller 4 performs the control of changing the location of the lens 5 in accordance with a signal from the controller 3. This solid-state imaging system includes a light-emitter (not shown) that emits light toward a subject E. In the camera 2, the light-emitter emits light toward the subject E. The light reflected by the subject E is received by the solid-state imaging device 1 via the lens 5.

The controller 3 is, for example, a PC including a CPU, a semiconductor memory, and any other suitable component. The controller 3 includes a failed row/column specifier 6 and an image processor 7 (i.e., a signal processor). The image processor 7 generates an output result of the solid-state imaging device 1 in accordance with the outputs from the solid-state imaging device 1 and the failed row/column specifier 6, and outputs data to the outside.

The failed row/column specifier 6 specifies the row or column including the effective pixel 101 (103) with a failure in the pixel array portion 10 in accordance with a signal output from the camera 2 (i.e., the solid-state imaging device 1). As described above, it is possible to detect a failure and specify a row and a column by arranging the failure detection pixels 102a to 102c (104a to 104c) in the row failure detection pixel area 10b and the column failure detection pixel area 10c of the pixel array portion 10. The failed row/column specifier 6 specifies the pixel row or the pixel column including the effective pixel 101 (103) with the failure, based on the outputs from the failure detection pixels 102a to 102c (104a to 104c).

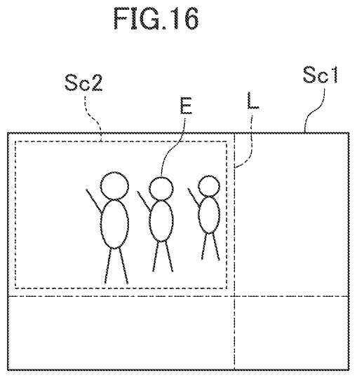

When the failed row/column specifier 6 specifies the effective pixel 101 (103) including the pixel row or column with the failure in the pixel array portion 10, the failed row/column specifier 6 outputs a signal to the lens controller 4 to control the orientation of the lens 5. For example, assume that an image Sc1 as shown in FIG. 16 can be generated from a signal output from the solid-state imaging device 1. In this case, when the failed row/column specifier 6 specifies that the pixel row or the pixel column including the effective pixel 101 (103) which has generated the section L (which is indicated by one dot chain line) has a failure, the failed row/column specifier 6 outputs a signal to the lens controller 4 to change the orientation of the lens 5 so that the image of the subject E does not overlap the section L. In FIG. 16, the failed row/column specifier 6 controls the orientation of the lens 5 so that the image of the subject E falls within an image area Sc2, for example. In this manner, the failed row/column specifier 6 (the controller 3) controls the camera 2 (the orientation of the lens 5) in accordance with a result output by the solid-state imaging device 1 so that information on the subject E is incident on the area of the effective pixels 101 (103) without a failure.

The failed row/column specifier 6 also outputs, to the image processor 7, information on the specified pixel row or pixel column including the effective pixel 101 (103) with the failure. The image processor 7 processes images based on the information. For example, the image processor 7 does not output data corresponding to the pixel row or the pixel column including the effective pixel 101 (103) with the failure. That is, the image processor 7 outputs data on the effective pixels other than the effective pixel 101 (103) with the failure in accordance with the result output by the solid-state imaging device 1.

According to the configuration described above, even if a failure occurs in some of the rows or columns of the pixel array portion 10 of the solid-state imaging device 1, the failed row/column specifier 6 and the lens controller 4 control the orientation of the lens 5 so that the image of the subject E is included in the area of the effective pixels 101 (103) without a failure. It is thus possible to operate the solid-state imaging system stably even in the event of a failure and reduce costs and the scale of the device.

With the configuration shown in FIG. 15, it is possible to operate the solid-state imaging device (or system) continuously even in the event of a failure of an effective pixel. For example, in a solid-state imaging system having a redundant configuration that includes a plurality of solid-state imaging devices, the solid-state imaging device in operation needs to be changed in the event of a failure of an effective pixel. This means time for changing solid-state imaging devices is required. Accordingly, if such a solid-state imaging system is mounted on an automobile or the like, there may be a safety risk. By contrast, in the configuration in FIG. 15, the solid-state imaging device (or system) can operate continuously, which requires no time for changing devices. Accordingly, if such a solid-state imaging system is mounted on an automobile or the like, safety risks can be reduced.

In the foregoing description, the embodiments serve as examples of the technique disclosed in the present application. However, the technique in the present disclosure is not limited to the embodiments, and is also applicable to embodiments where modifications, substitutions, additions, or omissions are made appropriately.

What is claimed is:

1. A solid-state imaging device comprising:
a plurality of effective pixels arranged in a matrix and each including a photodiode; and
a failure detection pixel configured to detect a failure in any of the effective pixels,
the effective pixels and the failure detection pixel being connected to a control signal line for controlling an operation of the pixels and to an output signal line for outputting a result of failure detection in the pixels,
among the plurality of effective pixels,
the effective pixels in a same row being connected in common to a same control signal line, and
the effective pixels in a same column being connected in common to a same output signal line,
the failure detection pixel being connected in common to at least one of the control signal line or the output signal line and configured to detect a failure in any of the effective pixels connected to the at least one of the control signal line or the output signal line.

2. The solid-state imaging device of claim 1, wherein
the failure detection pixel includes a first row failure detection pixel and a second row failure detection pixel having a configuration different from the first row failure detection pixel, and
the first and second row failure detection pixels are connected in common to the control signal line connected to the effective pixels in the same row.

3. The solid-state imaging device of claim 2, wherein
the failure detection pixel further includes a third row failure detection pixel having a configuration different from the first and second row failure detection pixels, and
the first to third row failure detection pixels are connected in common to the control signal line connected to the effective pixels in the same row.

4. The solid-state imaging device of claim 1, wherein
the control signal line includes a first control signal line connected in common to the effective pixels in a first row, and a second control signal line connected in common to the effective pixels in a second row different from the first row,
the failure detection pixel includes a fourth row failure detection pixel connected to the first control signal line and a fifth row failure detection pixel having a different configuration from the fourth row failure detection pixel and connected to the second control signal line, and
the fourth and fifth row failure detection pixels are connected in common to the same output signal line.

5. The solid-state imaging device of claim 1, wherein
the failure detection pixel includes a first column failure detection pixel and a second column failure detection pixel having a different configuration from the first column failure detection pixel, and
the first and second column failure detection pixels are connected in common to the output signal line connected to the effective pixels in the same column.

6. A solid-state imaging system comprising:
the solid-state imaging device of claim 1; and
a signal processor configured to output data on the effective pixels other than the effective pixels with a failure in accordance with a result output by the solid-state imaging device.

7. A solid-state imaging system comprising:
an optical system including the solid-state imaging device of claim 1; and
a controller configured to control the optical system in accordance with a result output by the solid-state imaging device so that information on a subject is incident on an area where the effective pixels without a failure are arranged.
